(19) United States
(12) Patent Application Publication
(10) Pub. No.: US 2004/0183659 A1
(43) Pub. Date: Sep. 23, 2004

(54) Digital message display for vehicles

(76) Inventor: Eddie Somuah, Milford, CT (US)

Correspondence Address: LITMAN LAW OFFICES, LTD., P.O. BOX 15035 CRYSTAL CITY STATION, ARLINGTON, VA, 22215, US

(21) Appl. No.: 10/390,711

(22) Filed: Mar. 19, 2003

(51) Int. Cl. B60Q 1/00

(52) U.S. Cl. 340/435

(57) ABSTRACT

The digital message display for vehicles detects a tailgater and automatically flashes a warning message, directed to the tailgater, on a message display that is located in the rear window of the vehicle in view of following traffic. In addition to the warning message directed to the tailgater, a distance display is located in view of the vehicle driver to indicate the distance of the tailgater. An audible alarm alerts the driver to the presence of the tailgater. Additionally, a wireless remote control device allows the driver to manually select and display one of a number of pre-defined safety and courtesy messages.

### BACKGROUND OF THE INVENTION

1. Field of the Invention

The present invention relates to a digital message display for vehicles, and particularly to a digital message display for vehicles having a sensing means to detect when a trailing vehicle is following too closely for the purpose of automatically displaying a message to the trailing vehicle.

2. Description of the Related Art

Digital message displays are well known, and have been employed in advertising signs, message boards or displays often seen in bars and restaurants, and a wide variety of commercial settings. Such displays are frequently used to promote sales, upcoming special events, and the like.

Digital message displays have also been used on vehicles. Used on vehicles, these displays often show commercial messages. Also, digital message displays have been used to offer greeting and safety messages to the drivers and passengers of other vehicles. U.S. Pat. No. 5,825,281, issued on Oct. 20, 1998 to R. McCreary, describes a method of displaying advertising messages. A digital message display shows one of a number of pre-defined messages. Each time the brake pedal is depressed, the message display is changed. The display, mounted on the top or the rear of a vehicle, conveys advertising messages to other vehicles, pedestrians, and others who happen to see the vehicle.

Another system that employs a vehicle-mounted digital display for commercial and advertising purposes is detailed in U.S. Pat. No. 6,060,993, issued on May 9, 2000 to E. Cohen. This system uses a wireless communication system, along with a GPS system, to display messages on command form a base station or based on geographic relevance as the vehicle moves between different locations.

U.S. Pat. No. 5,500,638, issued on Mar. 19, 1996 to I. George, discloses a vehicular goodwill message system that is intended to issue a message on command from the operator of a vehicle. The system allows for the display of four pre-defined messages including courtesy messages such as “SORRY!” or “THANK YOU!” that may be signaled to a trailing driver, and distress messages such as “PLEASE HELP” or “PLEASE CALL 911”. A control box includes a pushbutton for each message.

U.S. Pat. No. 5,905,434, issued on May 18, 1999 to P. Steffan, shows a vehicle communication device that is another example of a message display that allows the driver of a vehicle to select from a number of preset and pre-programmed messages to be displayed on a display device mounted on the exterior of the vehicle.

In addition to the commercial benefit of advertising signs, and the entertainment and courtesy value of messages that a driver might signal to a following vehicle, it is desired to use a vehicle mounted digital display to improve vehicular safety. Rear-end accidents while driving account for a significant number of all vehicle accidents. These may be caused, among numerous factors, by a driver following another vehicle too closely, or by the driver of a following vehicle simply being inattentive to the actions of the vehicle in front.

U.S. Pat. No. 6,300,870, issued on Oct. 9, 2001 to W. Nelson, discusses safety aspects in an automotive digital rear window display. The primary safety feature discussed, however, is merely that the message display may capture the attention of a following driver more quickly than conventional means such as the vehicle brake lights or the turn signals. While the display may indeed capture the attention of the following driver, it is not helpful if the leading driver is unaware of, and therefore cannot display a message in response to, a hazardous situation such as a tailgater.

None of the above inventions and patents, taken either singly or in combination, is seen to describe the instant invention as claimed. Thus a digital message display for vehicles solving the aforementioned problems is desired.

### SUMMARY OF THE INVENTION

The digital message display for vehicles is a digital message display, to be mounted in the rear window of an automobile, capable of displaying a number of pre-defined messages. Distance measuring sensors are mounted on the automobile's rear bumper to detect and determine the distance to a following vehicle. A computer processing unit, containing a program memory, is electrically connected to the display and the sensors and will cause a pre-determined message to be displayed when a following vehicle becomes too close. The system also has a remote control that may be used to show other courtesy messages on the display. An audible alarm and a distance display provide information to the vehicle's driver about the presence of, and the distance of, the trailing vehicle. The warning that is automatically issued to the following driver, along with the alert and distance information presented to the vehicle's driver, enhance safety and help to prevent a rear-end collision.

Accordingly, it is a principal object of the invention to provide a digital message display for vehicles that will detect a tailgating vehicle and display a warning message visible by the driver of the tailgating vehicle.

It is another object of the invention to provide a digital message display for vehicles that will detect a tailgating vehicle and simultaneously signal both a vehicle driver and the driver of the tailgating vehicle.

It is a further object of the invention to provide a digital message display for vehicles that allows a driver to manually select a courtesy message to be displayed to the driver and passengers of a following vehicle.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a digital message display for vehicles according to the present invention.

FIG. 2 is an environmental, perspective view of the remote control and distance display components of the digital message display for vehicles according to the present invention.

FIG. 3 is a block diagram of the message display for vehicles according to the present invention.

Similar reference characters denote corresponding features consistently throughout the attached drawings.

### DETAILED DESCRIPTION OF THE PREFERRED EMBODIMENTS

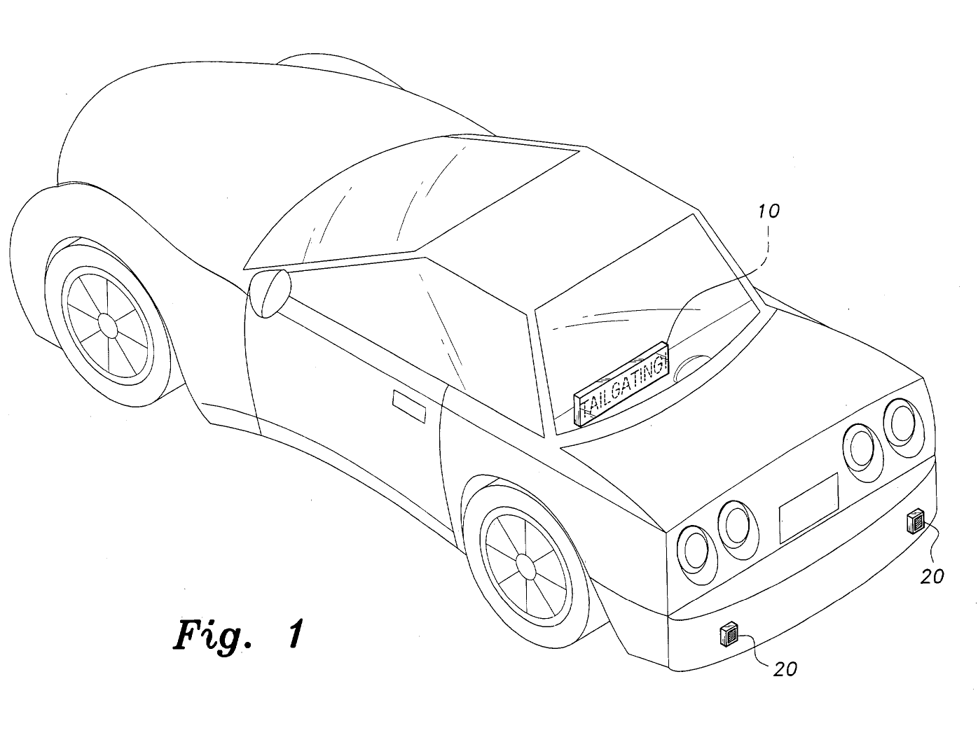

The present invention is a digital message display for vehicles. The digital message display for vehicles is a vehicle safety device that displays a warning message on a message display 10 when a tailgating vehicle is detected by distance sensors 20. FIG. 1 shows a preferred arrangement with the message display 10 disposed in a vehicle's rear window in view of following vehicles, and a pair of distance sensors 20 mounted on the vehicle's rear bumper.

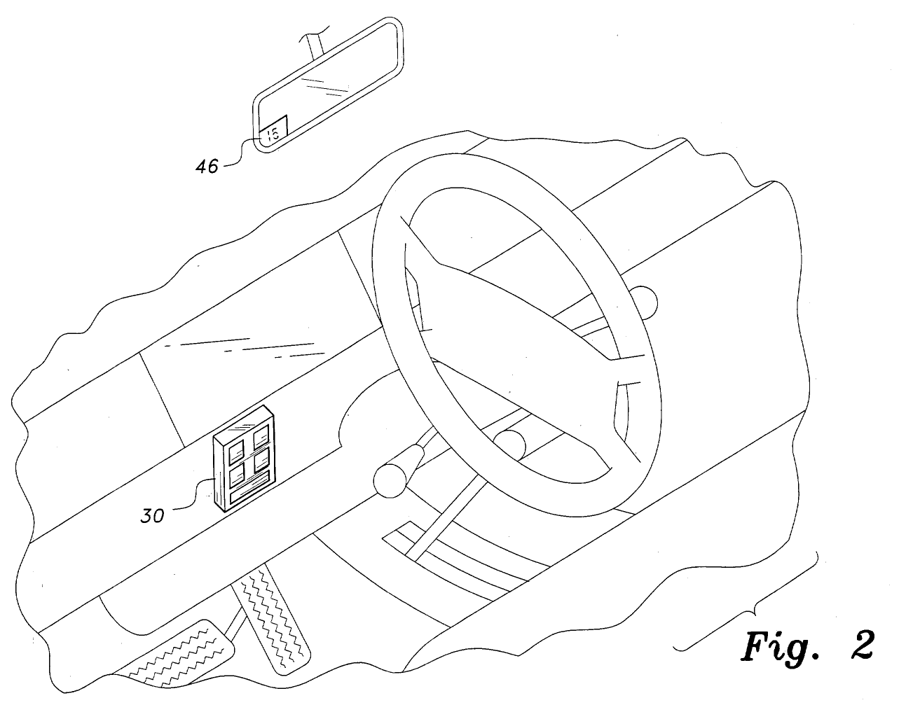

As shown in FIG. 2, the digital message display for vehicles includes a distance display 46 that displays the distance between the vehicle and the tailgater. A remote control 30 allows the driver to display additional safety and courtesy messages.

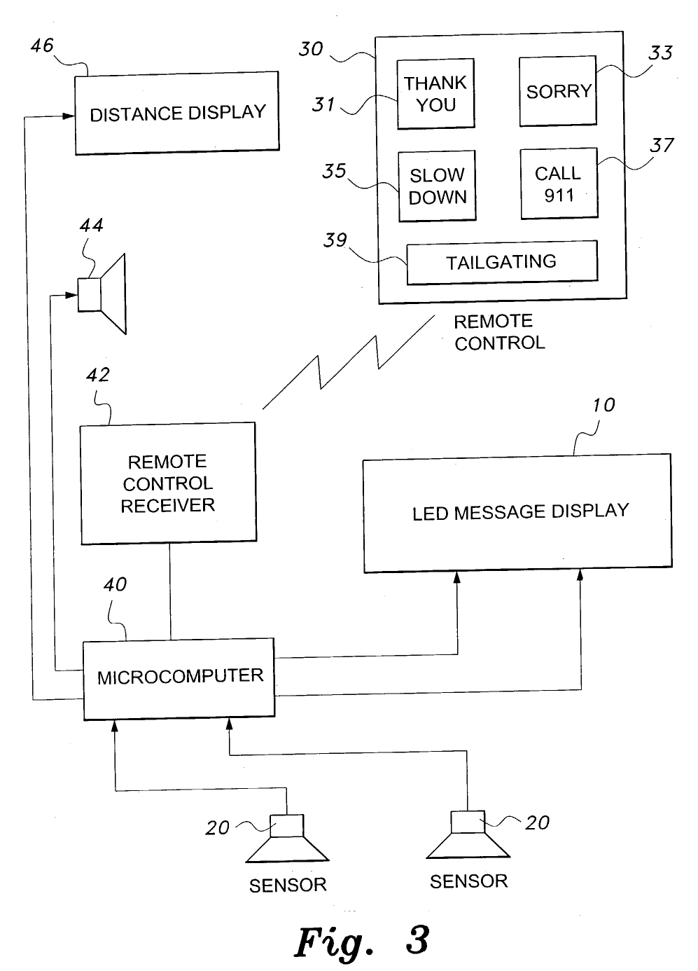

Referring now to FIG. 3, a microcomputer 40 is shown in electrical connection with a pair of distance sensors 20 and with the message display 10. The microcomputer 40 is one of a type well known in the art that contains a memory and program storage means. A microcomputer program is contained in the microcomputer 40. The microcomputer program functions to read the distance sensors 20 to determine the distance to a tailgating vehicle. When the microcomputer program determines that a tailgating vehicle is present and closer than a predetermined safety threshold, the microcomputer 40 causes a warning message to be displayed on the message display 10. A textual message such as “TAILGATING!” flashes on the message display 10 to alert the tailgating driver. Additionally, a distance display 46 may be electrically connected to the microcomputer 10. When the microcomputer program determines that a tailgater is present, the distance between the vehicle and the tailgater is displayed on the distance display 46. In a preferred embodiment, the distance display 46 is disposed in the vehicle's rear-view mirror. A beeper 44, also in connection with the microcomputer 40, emits an audible alarm to alert the driver to the tailgater's presence.

The remote control 30 communicates with a remote control receiver 42 that is in electrical connection to the microcomputer 40. The remote control 30 may communicate with the remote control receiver 42 over a wire connection or as is preferred, by a wireless means such as by infrared or RF. In the preferred embodiment, the remote control 30 transmits an RF signal that is received by the remote control receiver 42. The remote control 30 has a plurality of pushbuttons. When a pushbutton is depressed, a signal is transmitted to the remote control receiver 42, which in turn communicates the signal to the microcomputer 40. The microcomputer program will cause the message display 10 to display a unique predetermined message for each pushbutton that is depressed. In the embodiment illustrated, pushbutton 31 will cause the message “THANK YOU” to be displayed; pushbutton 33 displays “SORRY”; pushbutton 35 shows “SLOW DOWN”; pushbutton 37 shows “CALL 911”; and pushbutton 39 shows “TAILGATING”. Other messages could be pre-programmed in the microcomputer, but it is not intended that the messages are customizable by the users of the digital message display for vehicles.

It is to be understood that the present invention is not limited to the embodiments described above, but encompasses any and all embodiments within the scope of the following claims.

I claim:

1. A digital message display for vehicles comprising:
a message display;
at least one vehicle distance sensor;
a microcomputer in electrical connection with said message display and with said at least one vehicle distance sensor; and
a computer readable program code contained in said microcomputer, the program code having means for reading a trailing vehicle distance from said at least one vehicle distance sensor, means for determining when the trailing vehicle distance falls below a safety threshold, and means for displaying a message on said message display when the trailing vehicle distance falls below said safety threshold.

2. The digital message display for vehicles according to claim 1, wherein said message display is a light emitting diode display capable of displaying short textual messages.

3. The digital message display for vehicles according to claim 1, wherein said at least one vehicle distance sensor comprises two vehicle distance sensors.

4. The digital message display for vehicles according to claim 1, further comprising a beeper, the beeper being electrically connected to said microcomputer; and
wherein the computer program code further comprises means for causing the beeper to generate an audible alarm when the trailing vehicle distance falls below the safety threshold.

5. The digital message display for vehicles according to claim 1, further comprising a numeric distance display, the numeric distance display being electrically connected to said microcomputer; wherein the computer program code has means to cause the numeric distance display to display said trailing vehicle distance.

6. The digital message display for vehicles according to claim 5, wherein said numeric distance display is disposed in a vehicle rear-view mirror.

7. The digital message display for vehicles according to claim 1, further comprising:
a remote control having a plurality of pushbuttons; and
a remote control receiver in communication with said remote control, the remote control receiver being electrically connected to said microcomputer;
wherein the computer program code further comprises means for causing a pre-determined message to be displayed on said message display.

8. The digital message display for vehicles according to claim 7, wherein the plurality of pushbuttons comprises five pushbuttons.
